(19) United States
(12) Patent Application Publication
(10) Pub. No.: US 2026/0346198 A1
(43) Pub. Date: Nov. 5, 2026

(54) INTEGRATED CATALYTIC GAS SCRUBBING IN OXY-FUEL COMBUSTION PLANTS

(71) Applicant: NET Power LLC, Durham, NC (US)

(72) Inventors: Robert Krumm, Meridian, ID (US); Scott Thomas Martin, Salt Lake City, UT (US)

(73) Assignee: NET Power LLC, Durham, NC (US)

(21) Appl. No.: 19/645,636

(22) Filed: Apr. 13, 2026

Related U.S. Application Data
(60) Provisional application No. 63/789,139, filed on Apr. 15, 2025.

(51) Int. Cl. B01D 53/86; B01D 53/14; B01D 53/26

(52) U.S. Cl. CPC B01D 53/869; B01D 53/1481; B01D 53/26; B01D 53/864; B01D 53/8671; B01D 2257/104; B01D 2257/302; B01D 2257/404; B01D 2257/502; B01D 2257/80; B01D 2258/0283

(57) ABSTRACT

Methods and systems for processing a flue gas created in an oxy-fuel combustion plant are disclosed. The flue gas, containing CO, NOx, and O₂, is passed through a two-stage reactor where the contaminants are reduced and oxidized over metal catalysts. The resultant gas is dehydrated and compressed into an export gas.

### CROSS-REFERENCE TO RELATED APPLICATIONS

This application claims the benefit of U.S. Provisional Patent Application No. 63/789,139, filed Apr. 15, 2025 and entitled “Integrated Catalytic Gas Scrubbing in Oxy-Fuel Combustion Plants,” the entire contents of which are incorporated by reference herein.

### TECHNICAL FIELD

The present disclosure relates to systems and methods for scrubbing contaminants from a gas, for example in oxy-fuel combustion systems.

### BACKGROUND

Combustion systems, including the Allam Cycle, may utilize a carbonaceous fuel, an oxidant stream, and a recycled carbon dioxide stream to produce energy. The oxidant and recycle streams require energy inputs to produce. For certain details of the Allam Cycle, see U.S. Pat. No. 8,596,075, the entire contents of which are incorporated by reference herein.

### SUMMARY

In some examples, the present disclosure provides a system for processing a flue gas created in an oxy-fuel combustion plant. The flue gas includes CO, NOx, and O₂. The system includes a reactor to convert the flue gas to an intermediate gas. The reactor includes a first stage and a second stage operatively coupled to the first stage. The first stage reduces a first component of the flue gas using a first reagent over a first metal catalyst disposed on a first support. The second stage oxidizes a second component of the flue gas using a second reagent over a second metal catalyst disposed on a second support. The system includes a dehydrator to dehydrate the intermediate gas. The system includes a compressor to compress the intermediate gas into an export gas.

In some examples, the system includes a metering station to meter the export gas from the compressor into a CO₂ pipeline.

In some examples, the system includes a SOx scrubber to remove SOx from the flue gas before the reactor.

In some examples, the system includes a heat exchanger to heat the flue gas before the reactor by indirect contact with the intermediate gas.

In some examples, the first support is selected from the group consisting of TiO₂, alumina, zeolites, and ceramics. In some examples, the second support is selected from the group consisting of TiO₂, alumina, zeolites, and ceramics.

In some examples, the first metal catalyst includes one or more elements selected from the group consisting of nickel, ruthenium, rhenium, indium, iron, zinc, gold, silver, copper, molybdenum, zirconium, hafnium, platinum, palladium, rhodium, tungsten and vanadium. In some examples, the second metal catalyst includes one or more elements selected from the group consisting of nickel, ruthenium, rhenium, indium, iron, zinc, gold, silver, copper, molybdenum, zirconium, hafnium, platinum, palladium, rhodium, tungsten and vanadium.

In some examples, the export gas is at a pressure of about 150-250 bar.

In some examples, the system includes a gas analyzer to measure a concentration in the intermediate gas of one or more compounds selected from the group consisting of CO, NO, O₂, NH3, ozone, hydrogen peroxide, and hydroxide.

In some examples, the first component is NO and the first reagent includes one or more reactants selected from the group consisting of oxygen, hydrogen peroxide, hydroxide, and ozone.

In some examples, the first component is NO₂ and the first reagent includes one or more reactants selected from the group consisting of ammonia and water. In some examples, the system includes an NO₂ scrubber to scrub NO₂ from the intermediate gas.

In some examples, the first component is CO, the first reagent includes one or more reactants selected from the group consisting of oxygen, hydrogen peroxide, hydroxide, and ozone, and the first catalyst catalyzes a reaction between the first reagent and the CO to form CO₂.

In some examples, the second component is O₂, the second reagent includes one or more reactants selected from the group consisting of natural gas, methane, ammonia, and hydrogen, and the second catalyst catalyzes a reaction between the second reagent and the O₂.

In some examples, the first stage is located before the second stage.

In some examples, the second stage is located before the first stage.

In some examples, the present disclosure provides a method for processing a flue gas created in an oxy-fuel combustion plant. The flue gas may include CO, NOx, and O₂. The method includes converting the flue gas to an intermediate gas. The converting step includes reducing a first component of the flue gas using a first reagent over a first metal catalyst on a first support, oxidizing a second component of the flue gas using a second reagent over a second metal catalyst on a second support, dehydrating the intermediate gas, and compressing the intermediate gas into an export gas.

In some examples, the method includes metering the export gas into a CO₂ pipeline.

In some examples, the method includes scrubbing SOx from the flue gas.

In some examples, the method includes heating the flue gas before the converting step by indirect contact with the intermediate gas.

In some examples, the first support is selected from the group consisting of TiO₂, alumina, zeolites, and ceramics. In some examples, the second support is selected from the group consisting of TiO₂, alumina, zeolites, and ceramics.

In some examples, the first metal catalyst includes one or more elements selected from the group consisting of nickel, ruthenium, rhenium, indium, iron, zinc, gold, silver, copper, molybdenum, zirconium, hafnium, platinum, palladium, rhodium, tungsten and vanadium. In some examples, the second metal catalyst includes one or more elements selected from the group consisting of nickel, ruthenium, rhenium, indium, iron, zinc, gold, silver, copper, molybdenum, zirconium, hafnium, platinum, palladium, rhodium, tungsten and vanadium.

In some examples, the export gas is at a pressure of about 150-250 bar.

In some examples, the first component is NO₂ and the first reagent is selected from the group consisting of ammonia and water.

In some examples, the first component is NO and the first reagent is selected from the group consisting of oxygen, hydrogen peroxide, hydroxide, and ozone.

In some examples, the method includes scrubbing NO₂ from the slipstream of the flue gas in an NO2 scrubber before the dehydrator.

In some examples, the first component is CO and the first reagent is selected from the group consisting of oxygen, hydrogen peroxide, hydroxide, and ozone.

In some examples, the second component is O₂ and the second reagent is selected from the group consisting of natural gas, methane, ammonia, and hydrogen.

In some examples, the first component is O₂ and the first reagent is selected from the group consisting of natural gas, methane, ammonia, and hydrogen.

In some examples, the second component is CO and the second reagent is selected from the group consisting of oxygen, hydrogen peroxide, hydroxide, and ozone.

Further examples are provided in the drawings, detailed description, and claims.

### BRIEF DESCRIPTION OF DRAWINGS

The following drawings are provided to illustrate certain embodiments described herein. The drawings are merely illustrative and are not intended to limit the scope of the claims and are not intended to show every potential feature or embodiment that is claimed. The drawings are not necessarily drawn to scale; in some instances, certain elements of the drawing may be enlarged with respect to other elements of the drawing for purposes of illustration.

FIG. 1 is a process flow diagram showing an example system for processing a flue gas.

FIG. 2 is a process flow diagram showing an example system for processing a flue gas.

FIG. 3 is a block flow diagram showing an example method for processing a flue gas.

FIG. 4 is a block flow diagram showing an example method for processing a flue gas.

### DETAILED DESCRIPTION

The following description recites various aspects and embodiments of the subject matter disclosed herein. No particular embodiment is intended to define the scope of the present subject matter. Rather, the embodiments provide non-limiting examples of various compositions, and methods that are included within the scope of the claimed subject matter. The description is to be read from the perspective of one of ordinary skill in the art. Therefore, information that is well known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “about” means within ±10% of the stated value, e.g., within ±5% of the stated value, or within ±2% of the stated value.

Oxy-fuel combustion plants produce a flue gas containing a variety of contaminants. A portion of the flue gas is recycled as part of the oxy-fuel combustion unit operation, while a discharge stream is sent through contaminant removal to produce a pipeline grade CO₂ export gas. This requires the removal of each contaminant down to pipeline specifications. As some of the contaminants require oxidation and some require reduction, the removal process may use a two-stage reactor, with oxidation and reduction stages, in either order. This two-stage approach over metal catalysts on supports, followed by dehydration and compression, allows for production of pipeline specification grade CO₂ export gas.

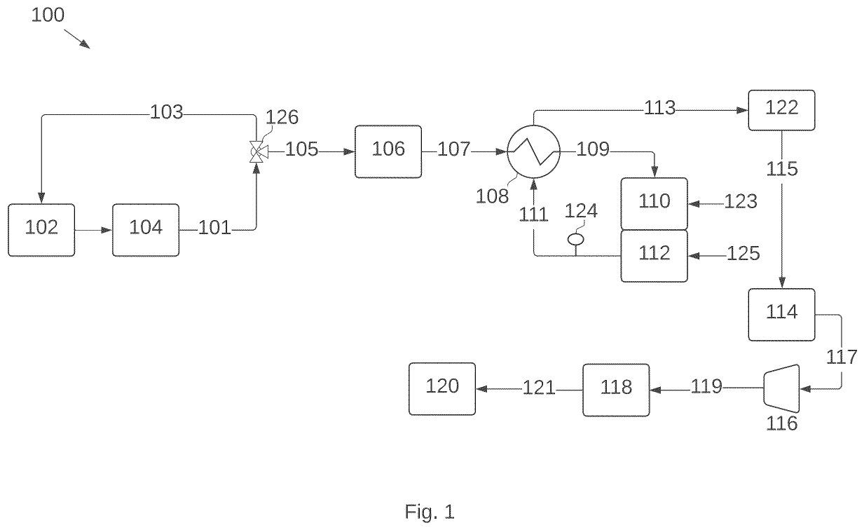

Now referring to FIG. 1, FIG. 1 is a process flow diagram showing an example system for processing a flue gas created in an oxy-fuel combustion plant. The flue gas may include CO, NOx, O₂, and SOx.

In some examples, system 100 includes a system for scrubbing SOx, NOx, CO, and O₂ from a process gas. In the nonlimiting configuration illustrated in FIG. 1, system 100 includes an oxy-fuel combustor and turbine 102, a first recuperative heat exchanger 104, a 3-way valve 126, a SOx scrubber 106, a second recuperative heat exchanger 108, a first stage reactor 110, a second stage reactor 112, a dehydrator 114, a compressor 116, a metering station 118, a pipeline 120, an NO₂ scrubber 122, and a contaminant measuring device 124.

A flue gas 101 is split into a recycle CO₂ stream 103 and a discharge stream 105 by 3-way valve 126. The recycle CO₂ stream 103 returns to the combustor and turbine 102, which produces the flue gas 101 after cooling in the first recuperative heat exchanger. The details of the oxy-combustion system are not presented, but the flue gas 101 contains at least CO, NOx, O₂, and SOx. The discharge stream 105 is scrubbed of SOx in SOx scrubber 106, generating stream 107. Stream 107 is pre-heated in second recuperative heat exchanger 108, generating reactor inlet stream 109. Reactor inlet stream 109 is reacted with reagent stream 123 in first stage reactor 110 and then with reagent stream 125 in second stage reactor 112, generating reactor discharge stream 111, which has contaminants measured by contaminant measuring device 124 as feedback control to prevent discharge of oxygen or other contaminants. Reagent stream 123 may include (and in some examples may consist essentially of) an oxidant, which oxidizes CO, NO, and any hydrocarbons. Reagent stream 125 may include (and in some examples may consist essentially of) a reducing agent, which reduces O₂. The resultant stream contains NO₂. The reactor discharge stream 111 is cooled by second recuperative heat exchanger 108. Stream 113 is then sent through NO₂ scrubber 122 where NO₂ is removed from stream 113, generating stream 115. Stream 115 is dehydrated in dehydrator 114, generating stream 117, which is compressed in compressor 116 to produce export gas 119. Export 119 is passed through metering station 118 and product CO₂ gas 121 is sent to pipeline 120.

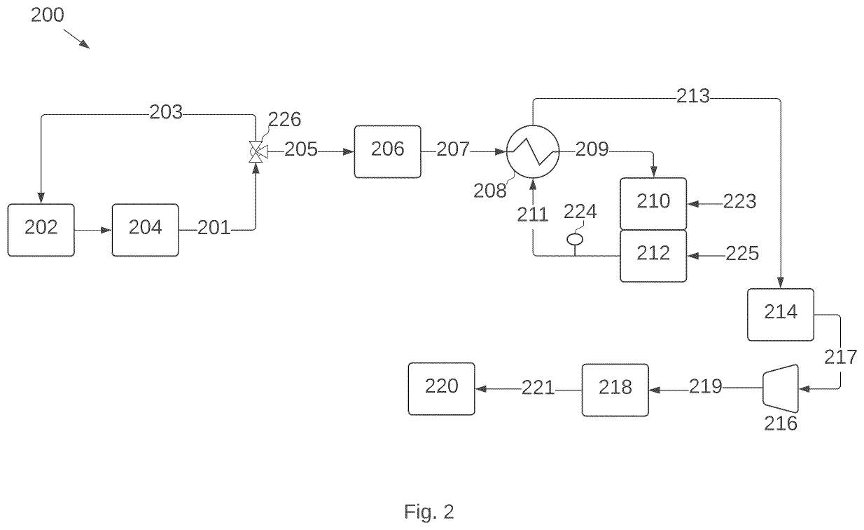

FIG. 2 is a process flow diagram showing an example system for processing a flue gas created in an oxy-fuel combustion plant. The flue gas may include CO, NOx, O₂, and SOx.

In some examples, system 200 includes a system for scrubbing SOx, NOx, CO, and O₂ from a process gas. In the nonlimiting configuration illustrated in FIG. 2, system 200 includes an oxy-fuel combustor and turbine 202, a first recuperative heat exchanger 204, a 3-way valve 226, a SOx scrubber 206, a second recuperative heat exchanger 208, a first stage reactor 210, a second stage reactor 212, a dehydrator 214, a compressor 216, a metering station 218, a pipeline 220, and a contaminant measuring device 224.

A flue gas 201 is split into a recycle CO₂ stream 203 and a discharge stream 205 by 3-way valve 226. The recycle CO₂ stream 203 returns to the combustor and turbine 202, which produces the flue gas 201 after cooling in the first recuperative heat exchanger. The details of the oxy-combustion system are not presented, but the flue gas 201 contains at least CO, NOx, O₂, and SOx. The discharge stream 205 is scrubbed of SOx in SOx scrubber 206, generating stream 207. Stream 207 is pre-heated in second recuperative heat exchanger 208, generating reactor inlet stream 209. Reactor inlet stream 209 is reacted with reagent stream 223 in first stage reactor 210 and then with reagent stream 225 in second stage reactor 212, generating reactor discharge stream 211, which has contaminants measured by contaminant measuring device 224 as feedback control to prevent discharge of oxygen or other contaminants. Reagent stream 223 may include (and in some examples may consist essentially of) a reducing agent, which reduces NO and NO₂ to N₂. Reagent stream 225 may include (and in some examples may consist essentially of) an oxidizing agent, which oxidizes CO and hydrocarbons. Any O₂ in the inlet stream 209 acts as the oxidizing agent 225 and only enough oxidant is added to complete oxidation of the CO and hydrocarbons. The reactor discharge stream 211 is cooled by second recuperative heat exchanger 208. Stream 213 is dehydrated in dehydrator 214, generating stream 217, which is compressed in compressor 216 to produce export gas 219. Export 219 is passed through metering station 218 and product CO₂ gas 221 is sent to pipeline 220.

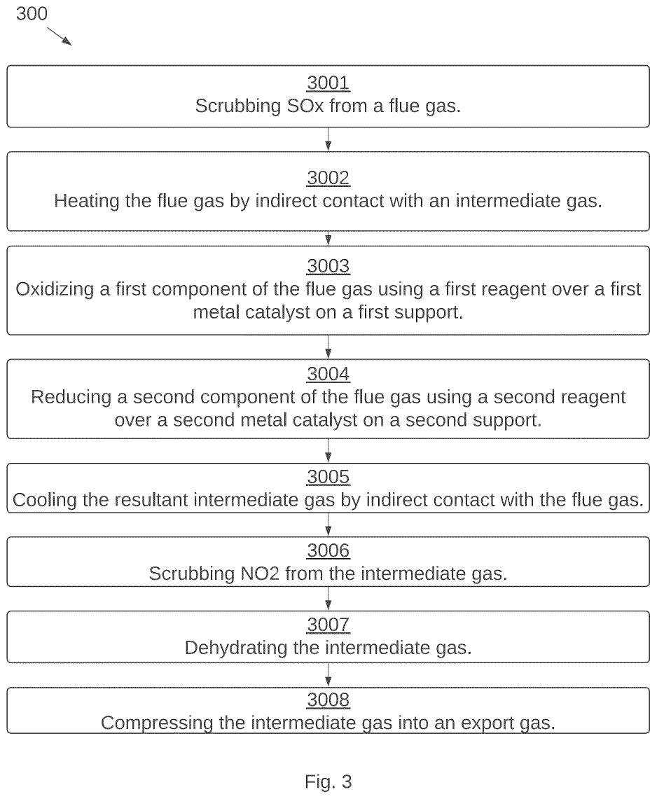

Illustratively, FIG. 3 is a block diagram showing an example method 3000 for processing a flue gas that may be used in some examples provided herein. The method. While method 3000 optionally may be implemented using system 100, it will be appreciated that any other suitable combination of components may be used to implement method 3000.

Method 3000 illustrated in FIG. 3 may include scrubbing SOx from a flue gas (operation 3001). For example, in a manner such as described above with reference to FIG. 1, flue gas 105 enters SOx scrubber 106 which removes SOx from the flue gas.

Referring again to FIG. 3, method 3000 may also include heating the flue gas by indirect contact with an intermediate gas (operation 3002). For example, in a manner such as described above with reference to FIG. 1, flue gas 107 is heated by indirect contact across second recuperative heat exchanger 108 with intermediate gas 111.

Referring again to FIG. 3, method 3000 may also include oxidizing a first component of the flue gas using a first reagent over a first metal catalyst on a first support (operation 3003). For example, in a manner such as described above with reference to FIG. 1, flue gas 109 is reacted with first reagent 123 in first reactor 110, containing the first metal catalyst on a first support.

Referring again to FIG. 3, method 3000 may also include reducing a second component of the flue gas using a second reagent over a second metal catalyst on a second support (operation 3004). For example, in a manner such as described above with reference to FIG. 1, flue gas 109 passes from first reactor 110 into second reactor 112, and is reacted with reagent 125 over a second metal catalyst on a second support.

Referring again to FIG. 3, method 3000 may also include cooling the resultant intermediate gas by indirect contact with the flue gas (operation 3005). For example, in a manner such as described above with reference to FIG. 1, intermediate gas 111 is cooled by indirect contact across second recuperative heat exchanger 108 with flue gas 107.

Referring again to FIG. 3, method 3000 may also include scrubbing NO₂ from the intermediate gas (operation 3006). For example, in a manner such as described above with reference to FIG. 1, intermediate gas 113 is scrubbed in NO₂ scrubber 122 to remove NO₂ from the intermediate gas 113.

Referring again to FIG. 3, method 3000 may also include dehydrating the intermediate gas (operation 3007). For example, in a manner such as described above with reference to FIG. 1, intermediate gas 115 has water removed in dehydrator 114.

Referring again to FIG. 3, method 3000 may also include compressing the intermediate gas into an export gas (operation 3008). For example, in a manner such as described above with reference to FIG. 1, intermediate gas 117 is compressed in compressor 116 to produce export gas 119. Further water removal may be required of export gas 119, which is not shown here.

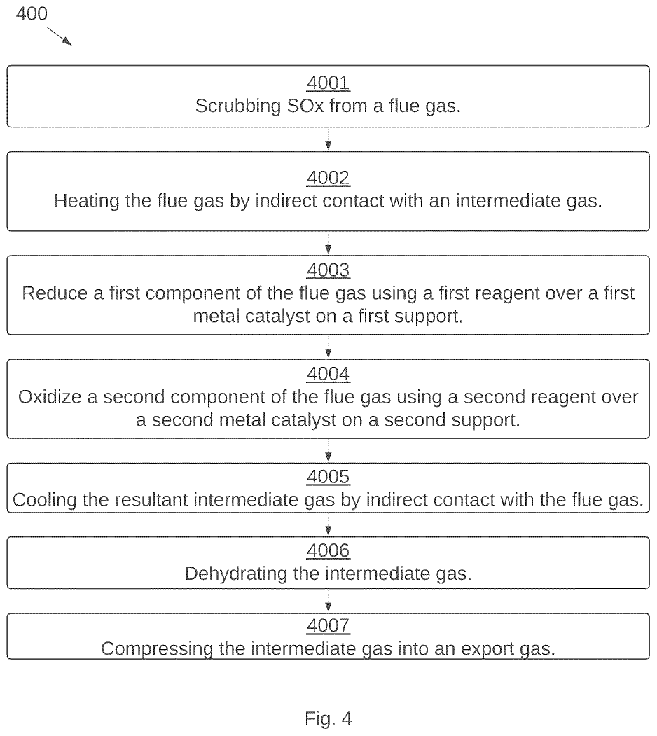

Illustratively, FIG. 4 is a block diagram showing an example method 4000 for processing a flue gas that may be used in some examples provided herein. The method. While method 4000 optionally may be implemented using system 200, it will be appreciated that any other suitable combination of components may be used to implement method 4000.

Method 4000 illustrated in FIG. 4 may include scrubbing SOx from a flue gas (operation 4001). For example, in a manner such as described above with reference to FIG. 2, flue gas 205 enters SOx scrubber 206 which removes SOx from the flue gas.

Referring again to FIG. 4, method 4000 may also include heating the flue gas by indirect contact with an intermediate gas (operation 4002). For example, in a manner such as described above with reference to FIG. 2, flue gas 207 is heated by indirect contact across second recuperative heat exchanger 208 with intermediate gas 211.

Referring again to FIG. 4, method 4000 may also include reducing a first component of the flue gas using a first reagent over a first metal catalyst on a first support (operation 4003). For example, in a manner such as described above with reference to FIG. 2, flue gas 209 is reacted with first reagent 223 in first reactor 210, containing the first metal catalyst on a first support.

Referring again to FIG. 4, method 4000 may also include oxidizing a second component of the flue gas using a second reagent over a second metal catalyst on a second support (operation 4004). For example, in a manner such as described above with reference to FIG. 2, flue gas 209 passes from first reactor 210 into second reactor 212, and is reacted with reagent 225 over a second metal catalyst on a second support.

Referring again to FIG. 4, method 4000 may also include cooling the resultant intermediate gas by indirect contact with the flue gas (operation 4005). For example, in a manner such as described above with reference to FIG. 2, intermediate gas 211 is cooled by indirect contact across second recuperative heat exchanger 208 with flue gas 207.

Referring again to FIG. 4, method 4000 may also include dehydrating the intermediate gas (operation 4006). For example, in a manner such as described above with reference to FIG. 2, intermediate gas 213 has water removed in dehydrator 214.

Referring again to FIG. 4, method 4000 may also include compressing the intermediate gas into an export gas (operation 4007). For example, in a manner such as described above with reference to FIG. 2, intermediate gas 217 is compressed in compressor 216 to produce export gas 219.

In some examples, the first support and the second support independently are selected from the group consisting of TiO₂, alumina, zeolites, and ceramics. In some examples, the first metal catalyst and/or the second metal catalyst independently include one or more elements selected from the group consisting of nickel, ruthenium, rhenium, indium, iron, zinc, gold, silver, copper, molybdenum, zirconium, hafnium, platinum, palladium, rhodium, tungsten and vanadium.

In some examples, the export gas is at a pressure of about 150-250 bar.

In some examples, the gas analyzer or gas analyzers (124 and 224) measures a concentration in the intermediate gas of one or more compounds selected from the group consisting of CO, NO, O₂, NH₃, ozone, hydrogen peroxide, and hydroxide.

In some examples, the first component is NO and the first reagent includes one or more reactants selected from the group consisting of oxygen, hydrogen peroxide, hydroxide, and ozone. In other examples, the first component consists of NO₂ and the first reagent includes one or more reactants selected from the group consisting of ammonia and water.

In some examples, the first component is CO, the first reagent includes one or more reactants selected from the group consisting of oxygen, hydrogen peroxide, hydroxide, and ozone, and the first catalyst catalyzes a reaction between the first reagent and the CO to form CO₂.

In other examples, the second component is O₂, the first reagent includes one or more reactants selected from the group consisting of natural gas, methane, ammonia, and hydrogen, and the second catalyst catalyzes a reaction between the second reagent and the O₂.

In some examples, the first stage is located before the second stage. In other examples, the second stage is located before the first stage.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

1. A system for processing a flue gas created in an oxy-fuel combustion plant, the flue gas comprising CO, NOx, and O₂, the system comprising:
a reactor to convert the flue gas to an intermediate gas, the reactor comprising a first stage and a second stage operatively coupled to the first stage,
the first stage to reduce a first component of the flue gas using a first reagent over a first metal catalyst disposed on a first support;
the second stage to oxidize a second component of the flue gas using a second reagent over a second metal catalyst disposed on a second support;
a dehydrator to dehydrate the intermediate gas; and
a compressor to compress the intermediate gas into an export gas.

2. The system of claim 1, further comprising a metering station to meter the export gas from the compressor into a CO₂ pipeline.

3. The system of claim 1, further comprising a SOx scrubber to remove SOx from the flue gas before the reactor.

4. The system of claim 1, further comprising a heat exchanger to heat the flue gas before the reactor by indirect contact with the intermediate gas.

5. The system of claim 1, wherein the first support, the second support, or both are selected from the group consisting of TiO₂, alumina, zeolites, and ceramics.

6. (canceled)

7. The system of claim 1, wherein the first metal catalyst, the second metal catalyst, or both comprise one or more elements selected from the group consisting of nickel, ruthenium, rhenium, indium, iron, zinc, gold, silver, copper, molybdenum, zirconium, hafnium, platinum, palladium, rhodium, tungsten and vanadium.

8. (canceled)

9. The system of claim 1, wherein the export gas is at a pressure of about 150-250 bar.

10. The system of claim 1, further comprising a gas analyzer to measure a concentration in the intermediate gas of one or more compounds selected from the group consisting of CO, NO, O₂, NH₃, ozone, hydrogen peroxide, and hydroxide.

11. The system of claim 1, wherein:
the first component comprises NO₂ and the first reagent comprises one or more reactants selected from the group consisting of ammonia and water; or
the first component comprises NO and the first reagent comprises one or more reactants selected from the group consisting of oxygen, hydrogen peroxide, hydroxide, and ozone.

12. (canceled)

13. The system of claim 11, further comprising an NO₂ scrubber to scrub NO₂ from the intermediate gas.

14. The system of claim 1, wherein:
the first component comprises CO,
the first reagent comprises one or more reactants selected from the group consisting of oxygen, hydrogen peroxide, hydroxide, and ozone, and
the first metal catalyst is to catalyze a reaction between the first reagent and the CO to form CO₂.

15. The system of claim 1, wherein:
the second component comprises O₂,
the second reagent comprises one or more reactants selected from the group consisting of natural gas, methane, ammonia, and hydrogen, and
the second metal catalyst is to catalyze a reaction between the second reagent and the O₂.

16. (canceled)

17. (canceled)

18. A method for processing a flue gas created in an oxy-fuel combustion plant, the flue gas comprising CO, NOx, and O₂, the method comprising:
converting the flue gas to an intermediate gas, the converting comprising:
reducing a first component of the flue gas using a first reagent over a first metal catalyst on a first support;
oxidizing a second component of the flue gas using a second reagent over a second metal catalyst on a second support;
dehydrating the intermediate gas; and
compressing the intermediate gas into an export gas.

19. The method of claim 18, further comprising metering the export gas into a CO₂ pipeline.

20. The method of claim 18, further comprising scrubbing SOx from the flue gas.

21. The method of claim 18, further comprising heating the flue gas before the converting by indirect contact with the intermediate gas.

22. The method of claim 18, wherein the first support, the second support, or both are selected from the group consisting of TiO₂, alumina, zeolites, and ceramics.

23. (canceled)

24. The method of claim 18, wherein the first metal catalyst, the second metal catalyst, or both comprise one or more elements selected from the group consisting of nickel, ruthenium, rhenium, indium, iron, zinc, gold, silver, copper, molybdenum, zirconium, hafnium, platinum, palladium, rhodium, tungsten and vanadium.

25. (canceled)

26. The method of claim 18, wherein the export gas is at a pressure of about 150-250 bar.

27. The method of claim 18, wherein:
the first component is NO₂ and the first reagent is selected from the group consisting of ammonia and water; or
the first component is NO and the first reagent is selected from the group consisting of oxygen, hydrogen peroxide, hydroxide, and ozone.

28. (canceled)

29. The method of claim 27, further comprising scrubbing NO₂ from a slipstream of the flue gas in an NO₂ scrubber before the dehydrating.

30. The method of claim 18, wherein the first component or the second component is CO and the first reagent or the second reagent is selected from the group consisting of oxygen, hydrogen peroxide, hydroxide, and ozone.

31. The method of claim 18, wherein:
the second component is O₂ and the second reagent is selected from the group consisting of natural gas, methane, ammonia, and hydrogen;
the first component is O₂ and the first reagent is selected from the group consisting of natural gas, methane, ammonia, and hydrogen; or
the second component is CO and the second reagent is selected from the group consisting of oxygen, hydrogen peroxide, hydroxide, and ozone.

32. (canceled)

33. (canceled)
